(19) United States
(12) Patent Application Publication
(10) Pub. No.: US 2008/0007035 A1
(43) Pub. Date: Jan. 10, 2008

(54) Airbag module

(75) Inventors: Dominique Acker, Gschwend (DE); Andreas Loos, Rechberghausen (DE); Gerd Zischka, Schwaebisch Grnuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/820,538

(22) Filed: Jun. 20, 2007

(30) Foreign Application Priority Data
Jun. 26, 2006 (DE) 10 2006 029 227.8

(51) Int. Cl. B60R 21/26

(52) U.S. Cl. 280/742

(57) ABSTRACT

In an airbag module having an airbag with at least one wall, and a gas guiding element which is rigid at least in sections and is made of plastic, the gas guiding element has a gas guiding portion in which several inside lying gas guiding channels are defined so as to lie side by side, which conduct gas from a gas generator in axially opposite directions to a first and a second opening.

### FIELD OF THE INVENTION

The invention relates to an airbag module.

### BACKGROUND OF THE INVENTION

A known airbag module comprises an airbag having at least one wall, a gas generator and a gas guiding element which is rigid at least in sections, is made of plastic and has a gas guiding portion which circumferentially surrounds the gas generator at least in sections.

Gas guiding elements, arranged either in direct proximity to or remote from a gas generator, are used in order to influence the gas flow into the airbag of a vehicle occupant protection system. For example, the distribution of the gas to various inflatable chambers of the airbag can be systematically regulated in this manner. Moreover, gas guiding elements can prevent hot gas coming directly from the gas generator from striking the wall of the airbag.

It is an object of the invention to provide a cost-efficient, compact solution for the gas conduction in an airbag module.

### BRIEF SUMMARY OF THE INVENTION

This is achieved in an airbag module having an airbag with at least one wall, and a gas guiding element which is rigid at least in sections and is made of plastic, the gas guiding element has a gas guiding portion in which several inside lying gas guiding channels are defined so as to lie side by side, the channels conducting gas from a gas generator in axially opposite directions to a first and a second opening.

This design allows a shape for the gas guiding element which is very compact and easy to produce. The gas guiding portion has a curved, three-dimensional shape which is well suited for conducting and collecting the gas from the gas generator and for transporting it into individual chambers of the airbag.

Preferably, the gas guiding channels are formed by the interspaces of ribs which radially protrude from an inner side of the gas guiding portion. By number, dimension and profile of the ribs, the gas flows through the gas guiding portion can be set in advance in a wide range, with these parameters being adaptable both in planning and manufacturing with low expenditure.

Especially in the region of the openings, the cross-sectional area of the first and/or second openings can be defined by the ribs, for instance by their shape and width. With an unchanging outer geometry of the gas guiding portion, the amount of gas that is flowing through can be readily adapted to different circumstances.

Whereas the radially outer delimitation of the gas guiding channels is constituted by the inner wall of the gas guiding portion, the gas guiding channels preferably are delimited in radial direction by an outer surface of the gas generator. This design simplifies the production of the gas guiding element e.g. during the injection-molding method.

It will be preferred that the ribs are distributed over the entire circumference of the gas generator. In case the entire direct surrounding area of the gas generator is used for the conduction of the gas, the diameter of the gas guiding element can be kept small, notwithstanding a specified conduction and distribution of the gas.

The gas guiding element can be realized with a substantially cylindrical outer circumference.

The gas guiding element preferably is made in one piece in an injection-molding process. The advantage is that the entire gas guiding element can be produced very economically in one step. The gas guiding element is not a fabric, not even in any sections, but rather a component that is solid although preferably flexible in sections.

In a preferred embodiment, the airbag has a first and a second inflatable chamber, and the gas guiding element has a first opening leading to the first inflatable chamber and a second opening leading to the second inflatable chamber, so that the gas guiding element systematically divides the gas stream from the gas generator and conducts it into the inflatable chambers. Different pressures could be achieved in the individual chambers. Of course, it would also be possible to provide a greater number of inflatable chambers and correspondingly more openings or else only one single inflatable chamber.

For securing the gas guiding element it is of advantage if it has a fastening portion which is connected with the gas guiding portion and fixed to the gas generator.

The fastening portion could alternatively be fixed to a module housing, e.g. at a mounting bracket for attachment to a vehicle.

For facilitating the assembly, the fastening portion preferably is designed so as to be flexible in radial direction.

The fastening portion of the gas guiding element can be realized with a wall thickness which is reduced compared with the gas guiding portion of the gas guiding element. This gives the fastening portion a certain flexibility. Of course, the thickness of the material has to be selected such that the stability is retained under the load that occurs when the airbag module is activated.

It will be preferred that the fastening portion axially extends in prolongation of the gas guiding portion, whereby it can be readily fixed on the gas generator.

The gas guiding element may have a predetermined breaking point that opens under predetermined conditions. This is advantageous, for example, under bonfire test conditions, to allow gas to exit the airbag module without the airbag being inflated.

The predetermined breaking point can be located at a suitable place, preferably in the gas guiding portion of the gas guiding element, and may be formed by a zone with reduced wall thickness, for instance.

The two portions of the gas guiding element have different functions. Accordingly, the shape, the material properties and the rigidity or flexibility of the portions can be variably adapted to the respective requirements.

In one embodiment of the invention, the gas guiding element and in particular the fastening portion is fixed to the airbag by sewing. To this end, the fastening portion should be designed so as to have a somewhat larger surface area and so as to be flexible, in order to be well-suited for being sewed with the large-area, flexible fabric of the airbag. According to the invention, the gas guiding element itself is connected directly to the airbag by a seam. For this purpose, a seam is created through the wall of the airbag and, at the same time, through the gas guiding element. Consequently, this fastening can be achieved with a work step that is quick and easy.

The fastening portion preferably projects radially from the gas guiding portion if the latter has a curved or tubular shape. The fastening portion is realized with a somewhat larger surface area whenever possible. The shape of a radially projecting fastening portion is very well suited for fastening a tubular gas generator in an airbag that can be laid flat.

In order to precisely arrange the gas guiding element in the airbag, at least one positioning opening may be provided in the gas guiding element for positioning the gas guiding element with respect to the wall of the airbag. This positioning opening is only used during the assembly of the airbag module, in order to precisely position the gas guiding element, for example, by using positioning aids, relative to the wall during the sewing procedure. Subsequently, the positioning aids are removed again and the gas guiding element is only connected to the airbag by means of the seam.

### SHORT DESCRIPTION OF THE DRAWINGS

FIG. 1 shows an airbag module according to the invention as a vehicle occupant restraint system, with a non-inflated airbag that has been laid flat;

FIG. 2 shows an assembly unit made up of a gas generator and a gas guiding element of an airbag module according to the invention;

FIG. 3 shows a section along line III-III in FIG. 1;

FIG. 4 shows a detail of the assembly unit of FIG. 2;

FIG. 5 shows a section along line V-V in FIG. 4;

FIG. 6 shows a schematic view of the underside of a gas guiding element of an airbag module according to the invention;

FIG. 7 shows a schematic side view of the gas guiding element in FIG. 6;

FIG. 8 shows a schematic view of the top side of the gas guiding element in FIG. 6;

FIG. 9 shows a cross-sectional view of the gas guiding element in FIG. 6;

FIG. 10 shows a schematic, perspective view of an assembly unit made up of a gas generator and a gas guiding element of an airbag module according to the invention, comprising a gas guiding element of FIG. 6;

FIG. 11 shows a schematic side view of the assembly unit in FIG. 10;

FIG. 12 shows a schematic top view of the assembly unit in FIG. 10; and

FIG. 13 shows a schematic sectional view of the assembly unit in FIG. 10.

### DETAILED DESCRIPTION OF PREFERRED EMBODIMENTS

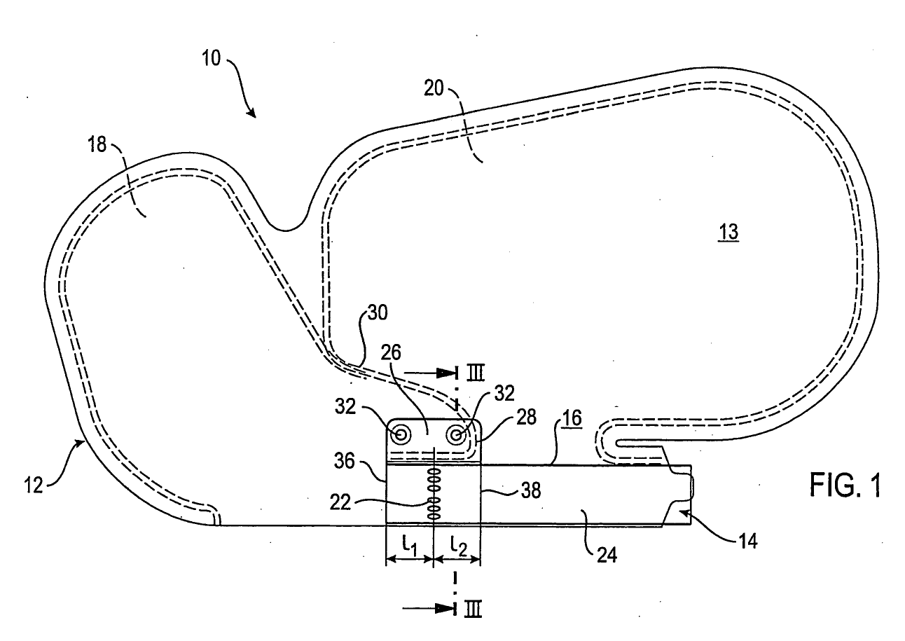

The airbag module 10 shown in FIG. 1 comprises an airbag 12, a gas generator 14 and a gas guiding element 16.

The airbag 12 consists of two layers of fabric laid flat on top of each other (in the non-inflated state), which are joined by means of seams along their circumference. Of the two fabric layers of the airbag 12, only the upper wall 13 of FIG. 1 is shown. The airbag is divided into two inflatable chambers 18, 20.

The airbag 12 can be used, for example, for side impact protection in the backrest of a car seat. However, the invention is not limited to the depicted form of the airbag or to the described application purpose. On the contrary, the invention can be used in any type of airbag with one or more inflatable chambers, also with woven or glued connections as well as in three-dimensional airbags having any desired number of pre-cut parts.

In the case shown here, the gas generator 14 is an elongated tubular gas generator that projects into the airbag 12. Outflow openings 22 of the gas generator 14 are positioned inside the airbag 12.

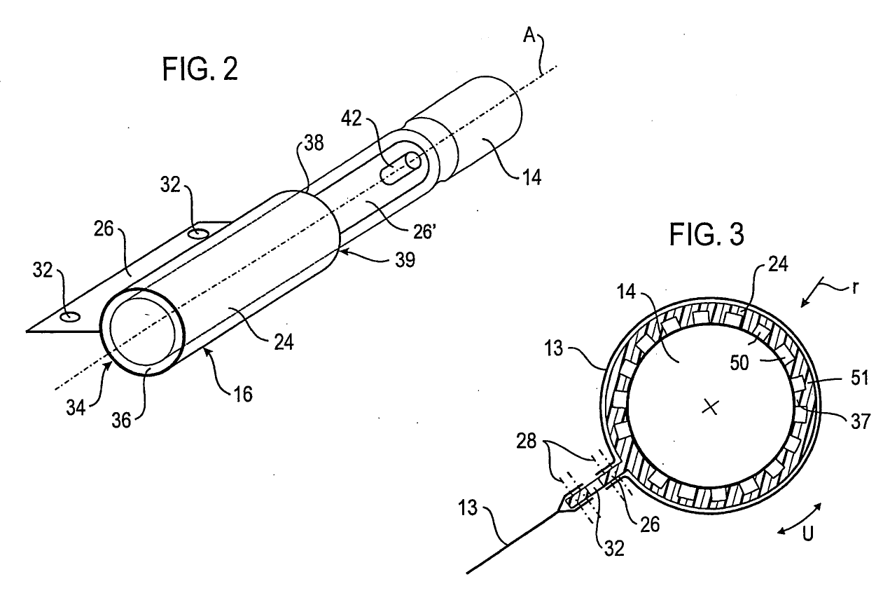

The gas guiding element 16 has a gas guiding portion 24 as well as a fastening portion 26 (shown in greater detail in FIGS. 2 and 3).

The entire gas guiding element 16 is a polymer component and here it is made in one piece of a polymer material through an injection molding process. The gas guiding portion 24 as well as the fastening portion 26 are made of solid plastic, thus not of fabric.

The gas guiding portion 24 has the task of distributing the gas coming from the gas generator 14 into the two chambers 18, 20 and of conducting the gas into the chambers 18, 20. Moreover, the gas guiding portion 24 also protects the fabric of the airbag 12 against gas flowing out of the gas generator 14.

The gas guiding element 16 is securely connected to the airbag 12 by means of the fastening portion 26. The fastening portion 26 is designed so as to provide a certain surface area and projects radially from the gas guiding portion 24, the fastening portion 26 lying parallel to the wall 13 of the airbag 12. A seam 28 runs through the wall 13 of the airbag 12 as well as through the material of the fastening portion 26, thus fastening the gas guiding element 16 to the airbag 12.

The seam 28 runs in a curve around the fastening portion 26 and then along the entire length of the fastening portion 26 parallel to the gas guiding portion 24, the seam 28 maintaining a specific distance to the free edges of the fastening portion 26. The seam 28 here is the extension of a seam 30 that effects the subdivision of the airbag 12 into the inflatable chambers 18, 20. It is also possible to provide several seams 28.

In the case shown here, the two fabric layers of the airbag 12 are joined to the fastening portion 26 by the seam 28.

The wall thickness of the fastening portion 26 is less than that of the gas guiding portion 24. The thickness of the fastening portion 26 is preferably in the range from 0.3 mm to 2.5 mm, the precise thickness depending, of course, on the material. The fastening portion 26 has a specific flexibility, which simplifies its processing together with the airbag 12.

The wall thickness of the gas guiding portion 24 is selected so as to be larger (preferably about 3 mm to 6 mm). The gas guiding portion 24 is so rigid that it is not deformed to an appreciable degree, even when the gas generator 14 is activated, so that it can always perform its gas guiding function.

The fastening portion 26 has essentially the same length as the gas guiding portion 24.

The fastening portion 26 has positioning openings 32 (here, two) that serve to exactly position the gas guiding element 16 with respect to the wall 13 of the airbag 12 when the gas guiding element 16 is fastened to the airbag 12. Before the sewing procedure, pins that serve as positioning aids (not shown) are inserted through these positioning openings 32; these positioning aids also project through corresponding openings in the airbag 12 so that no movement occurs between the gas guiding element 16 and the airbag 12 during the production of the seam 28. After the fastening portion 26 has been sewed to the wall 13 of the airbag 12, the pins are removed so that the gas guiding element 16 is only joined to the airbag 12 by the seam 28.

The gas guiding element 24 here is tubular and completely surrounds the gas generator 14 in the area of the outflow openings 22 of the gas generator 14.

A second fastening portion 26′ is shaped onto the gas guiding portion 24, which fastening portion is axially attached to the gas guiding portion 24 and extends along a longitudinal axis A of the gas generator 14. At the free end of the fastening portion 26′, an opening is provided which can be pulled over a bolt 42 of the gas generator 14, so that the gas guiding element 16 is additionally fastened to the gas generator 14.

Both axial ends 34, 39 of the gas guiding portion 24 are open. The gas guiding portion 24 (without the fastening portion 26′) extends over approximately one-third of the length of the gas generator 14, the front end of the gas generator 14 located in the airbag 12 ending with the end 34 of the gas guiding element 16. In the embodiment shown, the gas generator 14 projects at the back end out of the gas guiding portion 24 and out of the airbag 12. This is where the gas generator 14 can be electrically contacted so that it can be triggered by means of a control unit (not shown here) in case of an accident.

In the example presented here, the gas guiding portion 24 has a cylindrical shape along the entire length with an outer diameter which substantially is constant over its length. However, the outer diameter can also vary.

The end 34 of the gas guiding portion 24 directed to the chamber 18 forms a first opening 36 through which gas flows into the chamber 18, while the other end 39 forms a second opening 38 through which the chamber 20 is filled.

Due to the openings 36, 38, a thrust-neutrality of the airbag module 10 can be established for gas generators that are not intrinsically neutral in terms of thrust.

In the example presented, the distances I₁, I₂ from the outflow openings 22 to the first opening 36 and to the second opening 38 are selected so as to be the same. However, the distances I₁, I₂ between the outflow openings 22 and the first opening 36 and the second opening 38, respectively, could also be selected so as to be different, which can be utilized to influence the gas flow into the individual inflatable chambers 18, 20.

In the area of the end 34, ribs 37 are formed inside the gas guiding portion 24 that project from its inner wall 51 and are oriented radially inwards. The ribs 37 run parallel to the longitudinal axis A of the gas generator 14. The length of the ribs 37 in the radial direction r is coordinated such that their free ends extend as far as to the outer surface of the gas generator 14, so that between the ribs 37, the inner side 51 of the gas guiding portion 24 and the outer surface of the gas generator 14 several neighboring gas guiding channels 50 are formed through which the gas flows. In the case shown here, the gas guiding channels 50 all extend parallel to each other and parallel to the longitudinal axis A, and have the same cross-section. The gas guiding channels 50 substantially are uniformly distributed over the circumference U of the gas generator 14.

The flow cross-section of the gas guiding channels 50 and, hence, of the first opening 36 can be predefined by the number and thickness of the ribs 37.

Between and outside of the ribs 37, the wall of the gas guiding portion 34 may have a constant thickness along the length of the gas guiding portion 34, so that the diameter of the gas guiding portion 34 remains unchanged in the region of the inner wall 51 in axial direction A. However, it would also be possible to vary the wall thickness in a way that the inner wall 51 forms an outwardly opening cone (again, without regarding the rib structure). In the mounted state the cone starts at the outflow openings 22 of the gas generator 14 and ends at the respective opening 36, 38. A cone of this kind may be provided at each or only at one of the openings 36, 38.

In the example shown, no ribs are provided in the area of the second opening 38. Here, however, the same rib structure as for the opening 36 or else a different rib structure could be formed in order to systematically influence the flow cross-section.

The ribs 37 could also be oriented slanted or perpendicular to the longitudinal axis A. The person skilled in the art can adapt the thickness, orientation, number and radial or axial length of the ribs 37 and, hence, of the gas guiding channels 50, according to the desired gas flow.

The definition of the flow cross-sections of the openings 36, 38 by means of the ribs 37 can also be employed in any other airbag modules and completely independently of the fastening of the gas guiding element 16 by sewing. Of course, such ribs 37 can also be used with gas guiding elements that have only one or more than two openings.

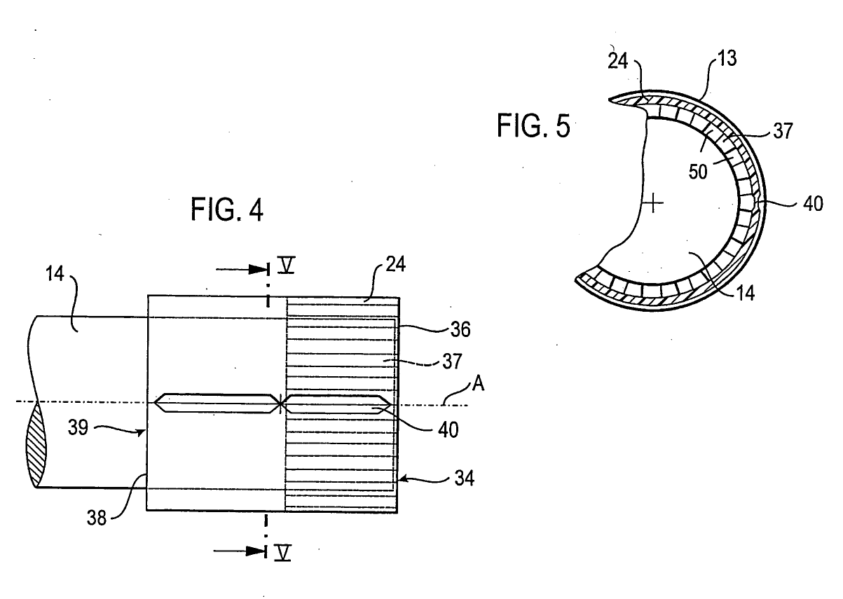

Moreover, the gas guiding portion 24 has one or more predetermined breaking points 40 that, in this case, are formed by a reduction in the wall thickness along the longitudinal axis A of the gas generator 14 (see FIGS. 4 and 5). The predetermined breaking points 40 are arranged in the area of the end 39 and, in the example presented, are formed by individual narrow strips having a reduced material thickness and arranged one behind the other and offset from each other. When a specific temperature and/or a specific internal pressure is exceeded (for example, under the conditions of a bonfire test), the gas guiding portion 24 opens in a defined manner along the predetermined breaking points 40 so that gas can exit from the airbag module 10 without the airbag 12 having to be unfolded.

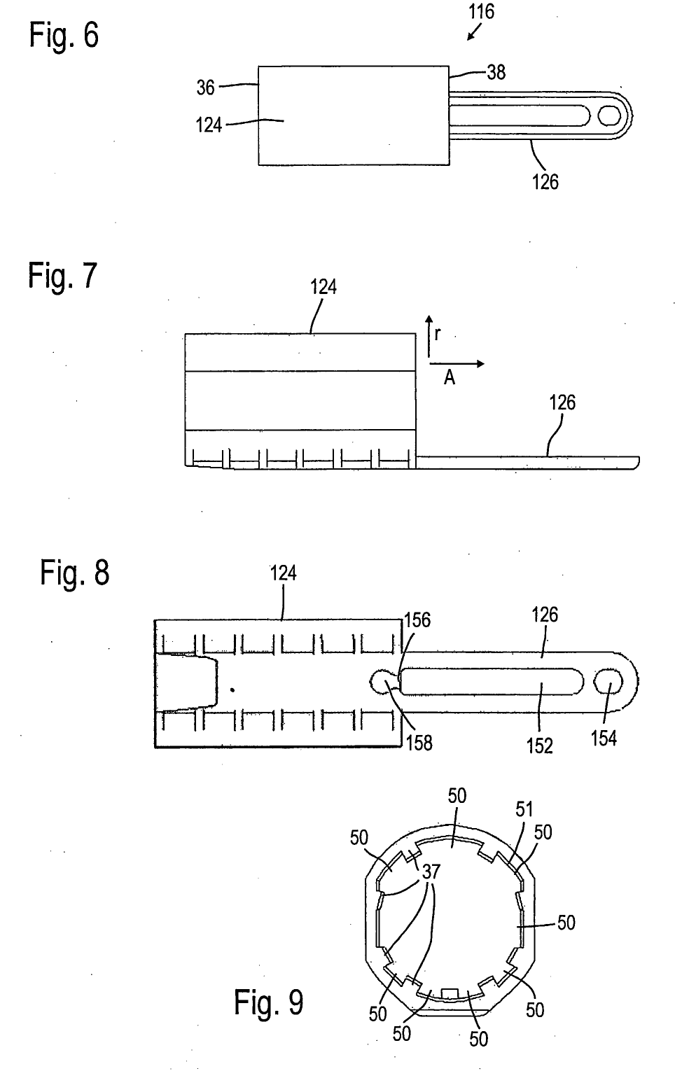

FIGS. 6 to 13 show an airbag module according to a second embodiment.

Here, the gas guiding element 126 only consists of a cylindrical, gas guiding portion 124 and a fastening portion 126 axially attached thereto.

The fastening portion 126 can be flexibly deflected in radial direction r. In order to achieve this design, the thickness of the material of the fastening portion 126 can be selected so as to be smaller than that of the gas guiding portion 124.

An elongated hole 152 and an opening 154 are formed in the fastening portion 126 behind one another, as seen in the longitudinal direction A from the gas guiding portion 124. The elongated hole 152 continues in the gas guiding portion 124 via a constriction 156 into a further opening 158.

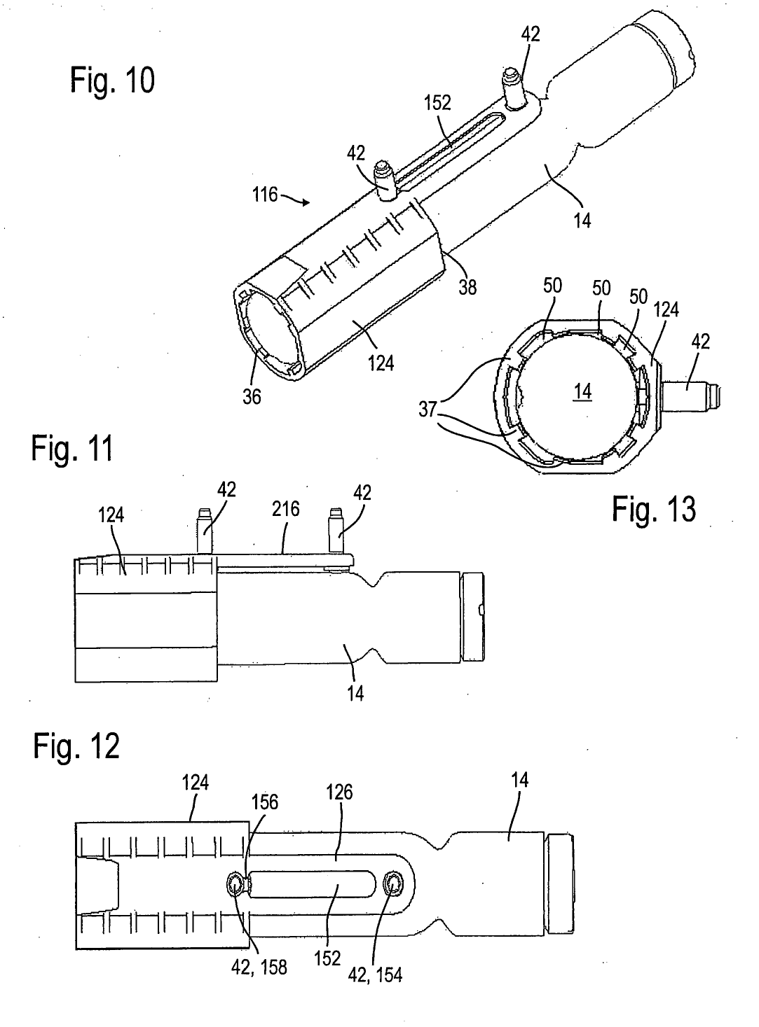

During assembly the gas guiding element 116 first of all is slightly tilted with respect to the gas generator 14 and, with the fastening portion 126 at the fore, is slipped on the gas generator 14 with the gas guiding portion 124, until the elongated hole 152 can be attached to the left one (FIG. 10) of the bolts 42 of the gas generator 14. Subsequently the gas guiding portion 124, now aligned so as to lie parallel to the gas generator 14, is slipped onto the latter so far until the free end of the fastening portion 126 abuts against the left bolt 42 (in FIG. 10) of the gas generator 14. The right bolt 42 is situated now at the left end (in FIG. 8) of the elongated hole 152 in front of the constriction 156.

Now the fastening portion 126 is radially lifted outwards and the entire gas guiding element 116 is further pulled in longitudinal direction A. In doing so, the constriction 156 slides over the left-hand bolt 42, so that the latter comes to lie in the opening 158.

The opening 154 is slipped over the right-hand bolt 42, so that the fastening portion 126 again is arranged parallel to the gas generator 14. Due to the fact that the bolts 42 are received in the openings 154, 158, the gas guiding element 116 is firmly fastened to the gas generator 14.

Several gas guiding channels 50 are integrated in the gas guiding portion 124 and distributed over the circumference of the gas guiding portion 124. For reasons of clarity, only some of the gas guiding channels 50 and ribs 37 have been provided with reference numbers in the Figures.

On the underside of the gas generator 14, being provided with the bolts 42, the gas guiding channels 50 have a smaller width than on the opposite top side of the gas generator 14, by the distance of the ribs 37 in the area of the underside being selected so as to be smaller than in the area of the top side.

The gas guiding channels 50 can be formed so as to continuously extend between the two openings 36, 38. It is likewise possible, however, to provide one or each of the openings 36, 38 with a proper set of gas guiding channels 50 which only extend between the outflow openings 22 of the gas generator 14 and the respective opening 36, 38. In this arrangement, the gas guiding channels 50 of the two sets are not connected with each other along the inner side of the gas guiding portion.

It will be understood that the features which have been described within the scope of the individual embodiments may be freely combined with each other or replaced by each other at the discretion of a person skilled in the art.

1. An airbag module comprising:
an airbag (12) having at least one wall (13),
a gas generator (14) and
a gas guiding element (16; 116) which is rigid at least in sections, is made of plastic and has a gas guiding portion (24; 124) which circumferentially surrounds the gas generator (14) at least in sections,
several gas guiding channels (50) being defined in the gas guiding portion (24; 124) so as to lie side by side in circumferential direction (U), said channels (50) conducting gas from the gas generator (14) in axially opposite directions to a first and a second opening (36, 38).

2. The airbag module according to claim 1, wherein the gas guiding channels (50) are formed by the interspaces of ribs (37) which radially protrude from an inner side (51) of the gas guiding portion (24; 124).

3. The airbag module according to claim 2, wherein the cross-sectional area of the first and/or second openings (36, 38) is defined by the ribs (37) in the area of the openings (36, 38).

4. The airbag module according to claim 2, wherein the gas guiding channels (50) are delimited in radial direction (r) by an outer surface of the gas generator (14).

5. The airbag module according to claim 2, wherein the ribs (37) are distributed over the entire circumference of the gas generator (14).

6. The airbag module according to claim 1, wherein the outer circumference of the gas guiding portion (24; 124) is substantially cylindrical.

7. The airbag module according to claim 1, wherein the airbag (12) has a first and a second inflatable chamber (18, 20) and gas is conducted to the first inflatable chamber (18) through a first opening (36) and to the second inflatable chamber (20) through the second opening (38).

8. The airbag module according to claim 1, wherein the gas guiding element (16; 116) has a fastening portion (26′; 126) which is connected with the gas guiding portion (24) and fixed to the gas generator (14).

9. The airbag module according to claim 8, wherein the fastening portion (26′; 126) is designed so as to be flexible in radial direction.

10. The airbag module according to claim 8, wherein the fastening portion (26; 26′; 126) has a wall thickness which is reduced compared with the gas guiding portion (24) of the gas guiding element (16).

11. The airbag module according to claim 8, wherein the fastening portion (26′; 126) axially extends in prolongation of the gas guiding portion (24).

12. The airbag module according to claim 1, wherein the gas guiding element (16) has a predetermined breaking point (40) that opens under predetermined conditions.

13. The airbag module according to claim 1, wherein the gas guiding element (16) is fastened to the airbag (12) by sewing.
